(19) United States
(12) Patent Application Publication
(10) Pub. No.: US 2025/0303472 A1
(43) Pub. Date: Oct. 2, 2025

(54) SUCTION UNIT FOR AN EXHAUST DEVICE AND ADDITIVE MANUFACTURING DEVICE COMPRISING AN EXHAUST DEVICE

(71) Applicant: TRUMPF Laser- und Systemtechnik SE, Ditzingen (DE)

(72) Inventor: Florian Schaede, Stuttgart (DE)

(21) Appl. No.: 19/237,019

(22) Filed: Jun. 13, 2025

Related U.S. Application Data
(63) Continuation of application No. PCT/EP2023/082631, filed on Nov. 22, 2023.

(30) Foreign Application Priority Data
Dec. 14, 2022 (DE) 10 2022 133 277.2

(51) Int. Cl. B22F 12/70; B22F 10/28; B33Y 30/00

(52) U.S. Cl. CPC B22F 12/70; B33Y 30/00; B22F 10/28

(57) ABSTRACT

A suction unit for an exhaust device for extracting a process gas out of a process chamber of an additive manufacturing device includes a first suction head and a second suction head for suctioning the process gas, and an exhaust channel for discharging the process gas suctioned by the first suction head and the second suction head. The first suction head is arranged or formed on the exhaust channel in front of the second suction head in an exhaust direction. The exhaust channel has a first channel segment with a first feed cross-section and a second channel segment with a second feed cross-section. The first feed cross-section has a flow cross-sectional area that is larger than a flow cross-sectional area of the second feed cross-section. The first suction head feeds into the first channel segment. The second suction head and the first channel segment feed into the second channel segment.

### CROSS REFERENCE TO RELATED APPLICATIONS

This application is a continuation of International Application No. PCT/EP2023/082631 (WO 2024/125985 A1), filed on Nov. 22, 2023, and claims benefit to German Patent Application No. DE 10 2022 133 277.2, filed on Dec. 14, 2022. The aforementioned applications are hereby incorporated by reference herein.

### FIELD

Embodiments of the present invention relate to a suction unit for an exhaust device. Embodiments of the present invention also relate to an additive manufacturing device comprising an exhaust device having a suction unit.

### BACKGROUND

Particularly in the case of additive manufacturing processes such as laser powder bed fusion (LPBF), production takes place in an inert gas atmosphere to ensure high production accuracy.

To create the inert gas atmosphere, known as “inerting”, a process chamber of the additive manufacturing device is typically pressurized with a process gas or inert gas, which flows into the interior of the process chamber via a process gas supply unit.

During additive manufacturing, however, the process gas is mixed or contaminated with suspended particles, such as swirled-up process powder, and/or production-related smoke, which reduces the quality of the additive manufacturing process.

Therefore, in the prior art, the contaminated process gas is usually extracted from the process chamber via an exhaust device. This places high demands on the exhaust device. In particular, the exhaust device must create a process chamber flow that is as uniform and turbulence-free as possible in order to enable effective extraction of the contaminated process gas and to prevent further process powder from being swirled up as well as the deflection of smoke and other process emissions in the direction of the powder bed.

In addition, special requirements are placed on exhaust devices that have a movable suction unit within the process chamber. Such exhaust devices are used, for example, in additive manufacturing devices that provide for parallel coating with process powder and solidification of process powder in a working cylinder. The suction unit is moved in the vicinity of the working cylinder to be coated in order to extract up swirled-up process powder as quickly as possible.

### SUMMARY

Embodiments of the present invention provide a suction unit for an exhaust device for extracting a process gas out of a process chamber of an additive manufacturing device. The suction unit includes a first suction head and a second suction head for suctioning the process gas within the process chamber, and an exhaust channel for discharging the process gas suctioned by the first suction head and the second suction head. The first suction head is arranged or formed on the exhaust channel in front of the second suction head in an exhaust direction. The exhaust channel has a first channel segment with a first feed cross-section and a second channel segment with a second feed cross-section. The first feed cross-section has a flow cross-sectional area that is larger than a flow cross-sectional area of the second feed cross-section. The first suction head feeds into the first channel segment. The second suction head and the first channel segment feed into the second channel segment.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective view of an additive manufacturing device comprising an exhaust device having two suction units according to some embodiments;

FIG. 2 shows the additive manufacturing device from FIG. 1 in a detailed perspective view of the suction units arranged on a coating unit of the additive manufacturing device according to some embodiments;

FIG. 3 shows the suction units of the exhaust device from FIGS. 1 and 2 in a view separated from the additive manufacturing device according to some embodiments; and

FIG. 4 shows one of the suction units from FIGS. 1 to 3 in a sectioned perspective view according to some embodiments.

### DETAILED DESCRIPTION

Embodiments of the invention provide a device for the turbulence-free and uniform extraction of process gas from a process chamber of an additive manufacturing device.

According to embodiments of the invention, a suction unit is provided. The suction unit is suitable or designed for arrangement on an exhaust device. In other words, an exhaust device can be equipped with the suction unit. The suction unit can have a pipe connection for this purpose. This makes it easy to retrofit or convert existing exhaust devices.

The suction unit is also suitable or designed for extracting a process gas from a process chamber of an additive manufacturing device. In addition, the suction unit can be designed for suctioning various types of gaseous media. The suction unit is typically designed for suctioning suspended particles contained in the gaseous medium, e.g., process powder.

The suction unit has a first suction head and a second suction head. In other words, the suction unit has at least two suction heads. The suction heads are designed for suctioning the process gas within the process chamber.

Each of the suction heads typically has an inflow surface through which the suctioned process gas flows into the respective suction head. Each of the suction heads can also have an outflow surface via which the suctioned process gas can be discharged from the respective suction head. The suction heads usually have a flow cross-section that tapers from the inflow surface to the outflow surface.

According to embodiments of the invention, the suction unit also has an exhaust channel. The exhaust channel is designed for discharging the process gases suctioned by the suction heads. In other words, the exhaust channel is designed to be arranged or attached to the outflow surfaces of the suction heads. Typically, the exhaust channel is designed to be arranged on an exhaust device, in particular in a gas-tight manner.

According to embodiments of the invention, the first suction head is arranged on or attached to the exhaust channel in front of the second suction head in an exhaust direction. Typically, the first suction head is further away from the pipe connection than the second suction head. The process gas suctioned by the first suction head typically covers a longer flow path within the exhaust channel than the process gas suctioned by the second suction head.

The exhaust channel has a first channel segment with a first feed cross-section and a second channel segment with a second feed cross-section. According to embodiments of the invention, the first suction head feeds into the first channel segment. In other words, the first channel segment with the first feed cross-section can be arranged on the outflow surface of the first suction head. In addition, the first channel segment and the second suction head feed into the second channel segment.

The first feed cross-section of the first channel segment has a flow cross-sectional area that is larger than a flow cross-sectional area of the second feed cross-section of the second channel segment.

In summary, a suction unit is provided which proposes the extraction of process gas with at least two suction heads. The funnel-shaped design favors the suction of process gas in a wide area around the suction head. Furthermore, it is proposed to compensate for a flow path-related pressure loss within the exhaust channel by adjusting the feed cross-section at the respective channel segment, whereby a uniform process volume flow per suction head can be achieved. The suction unit according to embodiments of the invention can thus ensure a uniform suction of process gas from the process chamber at relatively low flow velocities. The swirling up of the process powder caused by suction and the deflection of smoke and process emissions towards the powder bed due to turbulence in the process chamber flow can be effectively avoided.

In a preferred embodiment, the suction unit has at least one further channel segment and at least one further suction head. Preferably, the suction unit has a plurality of, in particular three, additional channel segments and a corresponding number of suction heads. A larger number of channel segments and suction heads facilitate an even more uniform extraction of process gas. The further channel segment is preferably arranged or formed on the exhaust channel downstream of the first channel segment and the second channel segment in the exhaust direction. Further preferably, the channel segment located upstream of the further channel segment in the exhaust direction and the further suction head feed into the further channel segment. For example, the second channel segment and a third suction head can feed into a third channel segment. Furthermore, for example, a fourth channel segment and a fifth suction head can feed into a fifth channel segment.

In a further preferred embodiment of the suction unit, the first channel segment projects into the second channel segment. In other words, the first channel segment overlaps the second channel segment along a longitudinal axis of the exhaust channel. In this case, the first channel segment can be used to guide the process gas flow through the second suction head. This favors a low-turbulence merging of the individual process gas flows through the suction heads within the exhaust channel.

A preferred further development of the embodiment provides that a plurality of, in particular all, channel segments project into the channel segment following the respective channel segment in the exhaust direction. In other words, neighboring channel segments project into each other in the exhaust direction. This can further promote low-turbulence flow merging.

In a preferred embodiment of the suction unit, the feed cross-sections have a decreasing flow cross-sectional area in the exhaust direction of the exhaust channel. In other words, the flow cross-sectional area of a feed cross-section is increasingly enlarged as the flow path within the exhaust channel increases. This allows the pressure loss at the exhaust heads arranged downstream in the exhaust direction to be increased in order to ensure the greatest possible equal distribution of volume flow across all suction heads.

Alternatively or additionally, the exhaust channel is designed in such a way that a channel cross-sectional area of the exhaust channel increases in an exhaust direction of the exhaust channel. In other words, the flow cross-section of the exhaust channel increases in the exhaust direction. This prevents pressure losses due to the merging of the process gas volume flows suctioned through the suction heads, which further promotes uniform suction.

In a preferred embodiment of the suction unit, at least one feed cross-section is designed as a circular sector or as an annular sector. This allows geometrically induced pressure losses to be kept to a minimum.

In a further preferred embodiment of the suction unit, the first channel segment delimits the second suction head. In other words, the first channel segment forms a wall of the second suction head. This means that the suction unit can be manufactured in a more resource-efficient way.

In a preferred embodiment of the suction unit, the suction heads are each delimited along a longitudinal axis of the channel by two segment walls, wherein the segment walls are formed in particular orthogonally to the longitudinal axis of the channel. This allows a suction area of the respective suction head to be effectively delimited in relation to the at least one further suction head. Adjacent suction heads along the longitudinal axis of the channel preferably have a common segment wall. This means that the suction unit can be produced even more cost-effectively and in a resource-saving manner.

In a preferred further development of the suction unit, the segment walls are designed in the form of a circular sector or annular sector. This allows the inlet area of the suction head to be designed with particularly low pressure loss.

In a preferred embodiment of the suction unit, the suction heads each have a first funnel wall and a second funnel wall. Preferably, the funnel walls form a funnel angle. The funnel angle can be between 30° and 270°, preferably between 45° and 135°, particularly preferably between 80° and 100°. The funnel angle can be used to delimit the inflow area of the suction head in the circumferential direction of the longitudinal axis of the channel.

In a further preferred design of the suction unit, the at least two suction heads have at least one common funnel wall. Preferably, all suction heads have at least one common funnel wall. In other words, at least one of the funnel walls, in particular both funnel walls, can extend over all the suction heads of the suction unit. This means that the suction unit can be manufactured even more cost-effectively.

In a preferred embodiment of the suction unit, the first and/or the second suction head, in particular all suction heads, are designed as a cylindrical sector or hollow cylindrical sector. The inventors have recognized that a cylindrical sector-like or hollow cylinder sector-like design of the suction heads is particularly effective in terms of uniform and low-turbulence suction of the process gas.

The suction heads can each have an extension along the longitudinal axis of the channel of at least 50 millimeters, preferably at least 100 millimeters, particularly preferably at least 250 millimeters. The extension of the suction heads along the longitudinal axis of the channel typically depends on the width of the process chamber and the number of suction heads.

The channel segments can each have a channel segment extension along the longitudinal axis of the channel. The channel segments can have a mean channel segment radius. The mean channel segment radius can be related to a change in the channel segment radius of the respective channel segment along the longitudinal axis of the channel and/or a change in the channel segment radius of the respective channel segment in the circumferential direction of the channel segment. Each channel segment preferably has a channel segment ratio between the channel segment extension and the mean channel segment radius of the respective channel segment. The channel segment ratio can be at least 1:1, preferably at least 2:1, particularly preferably at least 3:1. For example, if a channel segment has a channel segment extension of 90 millimeters, the average channel segment radius with a channel segment ratio of 3:1 is exactly 30 millimeters.

In a further preferred embodiment of the suction unit, at least two suction heads have the same extension along the longitudinal axis of the channel. Preferably, all suction heads of the suction unit have the same extension along the longitudinal axis of the channel. This allows process gas to be extracted uniformly from the process chamber.

Embodiments of the present invention also provide an additive manufacturing device. The additive manufacturing device has a process chamber and an exhaust device for extracting a process gas from the process chamber of the additive manufacturing device.

According to embodiments of the invention, the exhaust device has at least one suction unit, described above and below, which is arranged on the exhaust device. The suction unit is arranged at least predominantly within the process chamber.

In a preferred embodiment, the additive manufacturing device also has a coating unit for distributing process powder in a working plane of the additive manufacturing device. The suction unit is preferably arranged or formed on the coating unit. The suction unit is designed to follow a movement of the coating unit along an axis of movement. This means that the suction unit can be positioned in the vicinity of the powder coating and directly suction any process powder that is swirled-up.

In a preferred further development of the additive manufacturing device, the additive manufacturing device has at least two exhaust units described above and below. Preferably, both suction units are arranged or formed on the coating unit. Particularly preferably, a first suction unit is arranged or formed on the coating unit upstream along the axis of movement of the coating unit and a second suction unit is arranged or formed on the coating unit downstream along the axis of movement of the coating unit. This allows a particularly wide suction area to be formed.

In a preferred further development of the additive manufacturing device in combination with a suction unit having a funnel wall, the funnel wall of at least one suction head is formed parallel to the working plane of the additive manufacturing device. This allows suspended particles and/or process powder accumulated on the working plane to be picked up by the funnel wall.

The features mentioned above and those yet to be explained further can be used in each case individually or together in any desired expedient combinations. The embodiments shown and described should not be understood as an exhaustive list, but rather are of an exemplary character.

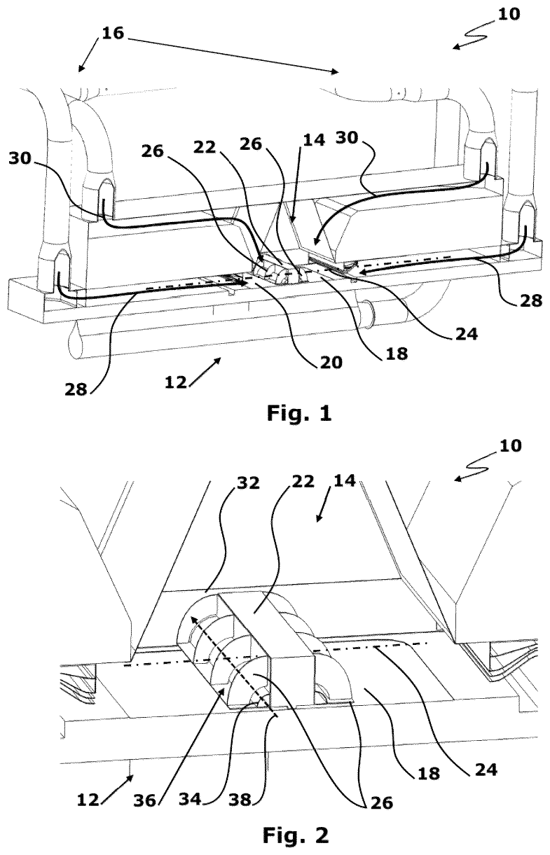

FIG. 1 shows a sectional view of the additive manufacturing device 10 according to the invention. The additive manufacturing device 10 has an exhaust device 12 for extracting process gas, not shown in detail, from a process chamber 14 of the additive manufacturing device 10.

The process gas can be supplied to the process chamber 14 via a process gas supply unit 16, for example. Process gas can also be produced during an additive manufacturing process, in particular during a powder bed-based laser metal fusion (LMF) process, for example in the form of smoke. The process gas to be extracted typically contains suspended particles.

As shown, the process chamber 14 can have a working cylinder 18. During the additive manufacturing process, the working cylinder 18 is gradually lowered relative to a working plane 20 of the process chamber 14. This creates a working trough, not shown, which is filled with process powder. In a subsequent method step, the process powder in the working trough is at least partially solidified. A laser unit, not shown in detail, can be used here, for example. The working cylinder 18 is then lowered again and further process powder is fed into the resulting working trough, which is then partially solidified again. The process steps are repeated until the workpiece is finished.

The working trough is typically filled with process powder by a coating unit 22. The coating unit 22 is moved along a movement axis 24 of the coating unit 22 above the working cylinder 18 in order to distribute the process powder uniformly in the working trough.

Preferably, the exhaust device 12 is arranged predominantly outside the process chamber 14, as shown. This means that the process chamber volume to be inerted can be kept low. According to the embodiment shown, the exhaust device 12 has two suction units 26, which are arranged within the process chamber 14 to enable the suction of the process gases.

The process gas supplied via the process gas supply unit 16 during additive manufacturing can flow into the process chamber 14 along main flow paths 28 and secondary flow paths 30, for example, and then be extracted from the process chamber 14 by the suction units 26. This ensures a uniform chamber flow and enables production under optimum process chamber conditions.

FIG. 2 shows a sectional view of the additive manufacturing device 10 of FIG. 1 with the coating unit 22 designed to distribute process powder in the working cylinder 18.

In the embodiment shown, the suction units 26 of the exhaust device 12 are arranged on or attached to the coating unit 22. In a particular embodiment, at least one of the suction units 26 can be formed on the coating unit 22.

As shown, the suction units 26 are arranged on the coating unit 22 upstream and downstream along the axis of movement 24 of the coating unit 22. In other words, the suction units 26 are arranged on opposite sides of the coating unit 22 along the axis of movement 24 of the coating unit 22. This favors the direction-independent extraction of process gas.

The suction units 26 or the exhaust device 12 is designed to follow a movement of the coating unit 22 along the axis of movement 24. In other words, the suction units 26 are designed to be movable together with the coating unit 22. For this purpose, the exhaust device 12 is typically designed to be at least partially movable outside the process chamber 14. The process chamber 14 typically has a movable, for example displaceable, chamber opening in a process chamber wall 32, through which the suction units 26 project into the process chamber 14.

As shown, each suction unit 26 can extend at least over the entire width of the working cylinder 18 transversely to the axis of movement 24. Preferably, each suction unit 26 extends across the entire width of the process chamber 14 transverse to the axis of movement 24. This enables a particularly uniform and turbulence-free extraction of the process gases.

The suction units 26 each have an exhaust channel 34 and—in this case—a plurality of suction heads 36. The suction heads 36 are arranged or formed on the respective exhaust channel 34 of the respective suction unit 26. For reasons of clarity, only one exhaust channel 34 and one suction head 36 of a suction unit 26 are provided with a reference sign.

During extraction, a negative overpressure or vacuum is generated in the exhaust channel 34 by the exhaust device 12 relative to the process chamber 14, whereby suction of process gas is effected at each suction head 36 of the respective suction unit 26. The suctioned process gas is then discharged from the process chamber 14 in an exhaust direction 38 via the exhaust channel 34.

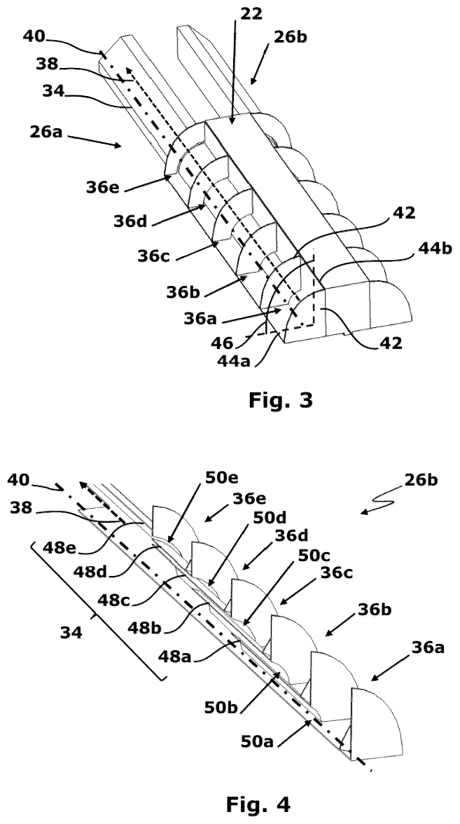

FIG. 3 shows the coating unit 22 and the suction units 26 from FIG. 2, which are also referred to below as the first suction unit 26a and the second suction unit 26b. In the following, for reasons of clarity, only the components of the first suction unit 26a are provided with a reference sign.

Each suction unit 26 has a first suction head 36a and a second suction head 36b for suctioning the process gas. Furthermore, as shown, each suction unit 26 has a third suction head 36c, a fourth suction head 36d and a fifth suction head 36e. The suction heads 36a-d are arranged on the respective exhaust channel 34 of the suction units 26. In other words, the suction heads 36 of the respective suction unit 26 have a common exhaust channel 34.

As shown, the first suction head 36a is arranged or attached or formed on the exhaust channel 34 in front of the second suction head 36b in the (fluidic) exhaust direction 38. The further suction heads 36c-e are arranged or formed on the exhaust channel 34 in a similar manner downstream of the first and second suction heads 36a, 36b in the exhaust direction 38. In other words, the suction heads 36 of a suction unit 26 are arranged in series along a longitudinal channel axis 40 on the exhaust channel 34. According to the embodiment shown in FIG. 3, the longitudinal axis 40 of the channel is designed as a straight line. Alternatively, it can be provided that the longitudinal axis of the channel 40 is curved. This allows the suction unit 26 to be adapted to the available process space. As shown, the longitudinal axis of the channel 40 is parallel to the exhaust direction 38.

According to the illustrated embodiment, each suction head 36 has at least two segment walls 42, which delimit the respective suction head 36 along the longitudinal axis 40 of the channel (for reasons of clarity, only the segment walls 42 of the suction head 36a are provided with a reference sign). The part of the suction unit 26 arranged in the process chamber 14 (see FIG. 2) can thus be divided into segments along the longitudinal axis 40 of the channel, wherein each segment comprises a suction head 36. Preferably, the suction heads 36 are delimited by walls which are orthogonal to the longitudinal axis 40 of the channel.

As shown, neighboring suction heads 36 can have a common segment wall 42. In other words, in this case neighboring suction heads 36 are adjacent to each other. As shown, the segment walls 42 can be circular segment-shaped or annular segment-shaped. This enables a low-loss flow to the suction head 36.

Each suction head 36 preferably has a first funnel wall 44a and a second funnel wall 44b, which delimit the respective suction head 36 parallel to the longitudinal axis 40 of the channel (for reasons of clarity, only the first and second funnel walls 44a, 44b of the suction head 36a are provided with a reference sign). As shown, the suction heads 36 can also be delimited by the exhaust channel 34. Preferably, the suction heads 36 are cylindrical sector-like, in this case suction heads 36a, or hollow cylinder sector-like, in this case suction heads 36b-e.

The first funnel wall 44a and the second funnel wall 44b form a funnel angle 46. The funnel angle 46 is preferably between 30° and 270°. This can create a uniform suction area at the suction head 36. According to the embodiment shown, the funnel angle 46 is approximately or exactly 90°. This allows the available installation space on the coating unit 22 to be used particularly effectively.

The first funnel wall 44a is preferably formed parallel to the working plane 20 (see FIG. 1) of the process chamber 14 (see FIG. 1). In this manner, the funnel wall 44a can be used to collect excess process powder, which is located on the working plane 20, for example, in the form of an accumulation.

As shown, the first funnel walls 44a and the second funnel walls 44b of the suction heads 36a-e can be formed in one piece. In other words, all suction heads 36a-e have the same funnel wall 44a or funnel wall 44b. This allows the suction heads 36 to be designed as a particularly cost-efficient structural unit.

As is also shown, it may be provided that the funnel walls 44a or 44b delimit the exhaust channel 34. In other words, the funnel walls 44a and 44b form a wall of the exhaust channel 34. This allows the suction unit 26 to be manufactured even more cost-effectively. FIG. 4 shows the suction unit 26b from FIG. 3 in a sectioned perspective view.

As shown, the exhaust channel 34 has a first channel segment 48a and a second channel segment 48b. Furthermore, the exhaust channel 34 has a third channel segment 48c, a fourth channel segment 48d and a fifth channel segment 48e.

The channel segments 48a-e are fluidically connected in series in the exhaust direction 38. As shown, the channel segments 48a-e can at least partially overlap along the longitudinal axis 40 of the channel. In other words, the channel segments 48a-e can project at least partially into one another. In particular, at least one upstream channel segment 48a-d in the exhaust direction 38 projects into the downstream channel segment 48a-e in the exhaust direction 38 up to a channel segment 48c-e that is next but one in the exhaust direction. Preferably, a plurality of channel segments 48a-d upstream in the exhaust direction 38 project into the channel segment 48b-e downstream in the exhaust direction 38 as far as a channel segment 48c-e which is next but one in the exhaust direction 38. Alternatively or additionally, a channel segment 48a-e, in this case channel segment 48c, can project completely into another channel segment 48a-e, in this case channel segment 48d.

Typically, the channel segments 48a-d located upstream in the exhaust direction 38 have a smaller radial extension relative to the longitudinal channel axis 40 than the channel segments 48b-e located downstream in the exhaust direction 38.

According to the embodiment of the suction unit 26b shown in FIG. 4, the fifth suction head 36e feeds the fifth channel segment 48e in the exhaust direction 38 via a fifth feed cross-section 50e of the fifth channel segment 48e into the fifth channel segment 48e. In addition, the fourth channel segment 48d and the third channel segment 48c feed into the fifth channel segment 48e.

The fourth suction head 36d feeds into the fourth channel segment 48d in the exhaust direction 38 via a fourth feed cross-section 50d of the fourth channel segment 48d.

The third suction head 36c feeds into the third channel segment 48c in the exhaust direction 38 via a third feed cross-section 50c of the third channel segment 48c. Furthermore, the second channel segment 48b feeds into the third channel segment 48c.

The second suction head 36b feeds into the second channel segment 48b in the exhaust direction 38 via a second feed cross-section 50b of the second channel segment 48b. Furthermore, the first channel segment 48a feeds into the second channel segment 48b.

The first suction head 36a feeds into the first channel segment 48a in the exhaust direction 38 via a first feed cross-section 50a of the first channel segment 48a.

The feed cross-sections 50a-e typically have the smallest flow cross-sectional area of the respective channel segment 48a-e. In other words, the feed cross-section 50a-e delimits the volume flow of process gas that can be extracted through the respective channel segment 48a-e. Preferably, the flow cross-sectional area of the feed cross-sections 50a-e decreases in the exhaust direction, in particular continuously. In this way, a volume flow of process gas suctioned via the suction heads 36 can be kept constant for the suction heads 36, regardless of a pressure loss in the exhaust channel 34.

In contrast, a radial extension of the exhaust channel 34 in the exhaust direction 38 preferably increases, whereby unnecessary pressure losses as a result of a larger totalized volume flow through the individual suction heads 36 are avoided.

The channel segments 48a-e can form a circular sector-like or annular channel segment cross-section. Preferably, the feed cross-sections 50a-e are circular segment-like, in this case feed cross-section 50a, or annular, in this case feed cross-sections 50b-e.

As shown, a channel segment 48a-e, into which a certain suction head 36a-e feeds, can delimit the suction head 36b-e following in the exhaust direction 38 in the form of a wall. For example, the first channel segment 48a forms a wall of the second suction head 36b.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Additive manufacturing device 10;
Exhaust device 12;
Process chamber 14;
Process gas supply unit 16;
Working cylinder 18;
Working plane 20;
Coating unit 22;
Axis of movement 24;
Suction unit 26, 26a, 26b;
Main flow path 28;
Secondary flow path 30;
Process chamber wall 32;
Exhaust channel 34;
Suction head 36, 36a-e;
Exhaust direction 38;
Longitudinal channel axis 40;
Segment wall 42;
Funnel wall 44a, b;
Funnel angle 46;
Channel segment 48a-e;
Feed cross-section 50a-e.

1. A suction unit for an exhaust device for extracting a process gas out of a process chamber of an additive manufacturing device, the suction unit comprising:
a first suction head and a second suction head for suctioning the process gas within the process chamber; and
an exhaust channel for discharging the process gas suctioned by the first suction head and the second suction head;
wherein the first suction head is arranged or formed on the exhaust channel in front of the second suction head in an exhaust direction;
wherein the exhaust channel has a first channel segment with a first feed cross-section and a second channel segment with a second feed cross-section;
wherein the first feed cross-section has a flow cross-sectional area that is larger than a flow cross-sectional area of the second feed cross-section; and
wherein the first suction head feeds into the first channel segment, and the second suction head and the first channel segment feed into the second channel segment.

2. The suction unit according to claim 1, comprising at least one further channel segment and at least one further suction head, wherein the further channel segment is arranged or formed on the exhaust channel downstream of the first channel segment and the second channel segment in the exhaust direction, wherein the further suction head, and the first channel segment and/or the second channel segment located upstream of the further channel segment in the exhaust direction feed into the further channel segment.

3. The suction unit according to claim 1, wherein the first channel segment projects into the second channel segment.

4. The suction unit according to claim 2, wherein the first channel segment projects into the second channel segment, and the second channel segment projects into the further channel segment.

5. The suction unit according to claim 1, wherein each of the first feed cross-section and the second feed cross-section has a decreasing flow cross-sectional area in the exhaust direction of the exhaust channel.

6. The suction unit according to claim 1, wherein at least one of the first feed cross-section and the second feed cross-section is configured as a circular sector or as an annular sector.

7. The suction unit according to claim 1, wherein the first channel segment delimits the second suction head.

8. The suction unit according to claim 1, wherein each of the first suction head and the second suction head is delimited along a longitudinal channel axis by two segment walls, wherein the two segment walls are formed orthogonally to the longitudinal channel axis.

9. The suction unit according to claim 8, wherein the two segment walls are configured in a form of a circular sector or an annular sector.

10. The suction unit according to claim 1, wherein each of the first suction head and the second suction head has a first funnel wall and a second funnel wall, wherein each of the first funnel wall and the second funnel wall forms a funnel angle.

11. The suction unit according to claim 10, wherein the funnel angle is between 30° and 270°.

12. The suction unit according to claim 1, wherein the first suction head and the second suction head have common funnel walls.

13. The suction unit according to claim 1, wherein the first suction head and/or the second suction head are configured in a form of a cylindrical sector.

14. The suction unit according to claim 1, wherein the first suction head and the second suction head have a same extension along a longitudinal axis of the channel.

15. An additive manufacturing device comprising an exhaust device for extracting process gases from a process chamber of the additive manufacturing device, and at least one suction unit according to claim 1.

16. The additive manufacturing device according to claim 15, further comprising a coating unit for distributing process powder in a working plane of the additive manufacturing device, wherein the at least one suction unit is arranged or formed on the coating unit and is configured to follow a movement along an axis of movement of the coating unit.

17. The additive manufacturing device according to claim 16, comprising at least two suction units, wherein a first suction unit is arranged or formed on the coating unit upstream along the axis of movement of the coating unit, and a second suction unit is arranged or formed on the coating unit downstream along the axis of movement of the coating unit.

18. The additive manufacturing device according to claim 16, wherein each of the first suction head and the second suction head of the at least one suction unit has a first funnel wall and a second funnel wall, at least one of the first funnel wall and the second funnel wall of the first suction head or the second suction head is formed parallel to a working plane of the additive manufacturing device.
